(19) United States
(12) Patent Application Publication
(10) Pub. No.: US 2024/0259943 A1
(43) Pub. Date: Aug. 1, 2024

(54) RECEIVING SYSTEM INFORMATION VIA WAKE UP RADIO SIGNALS

(71) Applicant: QUALCOMM Incorporated, San Diego, CA (US)

(72) Inventors: Ahmed Elshafie, San Diego, CA (US); Diana Maamari, San Diego, CA (US); Huilin Xu, Temecula, CA (US); Yuchul Kim, San Diego, CA (US); Linhai He, San Diego, CA (US)

(21) Appl. No.: 18/161,731

(22) Filed: Jan. 30, 2023

(51) Int. Cl. H04W 52/02

(52) U.S. Cl. CPC H04W 52/0235; H04W 52/0229

(57) ABSTRACT

Methods, systems, and devices for wireless communications are described. For example, the described techniques provide for reception of system information via a wake up radio of a user equipment (UE). The network may indicate a configuration for receiving system information via the wake up radio (e.g., a second radio of the UE), where the wake up radio receiver uses less power than the main radio of the UE (e.g., the first radio of the UE). The network entity may transmit a signal(s) for reception via the wake up radio that include system information that would be included in a master information block (MIB), a system information block (SIB), and/or a synchronization signal block (SSB), for example to reduce latency associated with waking up the main radio from a sleep mode or in order to increase bandwidth and/or provide additional system information or more frequent system information to the UE.

### TECHNICAL FIELD

The following relates to wireless communications, including receiving system information via wake up radio signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

### SUMMARY

The described techniques relate to improved methods, systems, devices, and apparatuses that support receiving system information via wake up radio signals. For example, the described techniques provide for reception of system information via a wake up radio of a user equipment (UE). A network entity may indicate a configuration for (e.g., one or more parameters) receiving system information via the wake up radio (e.g., a second radio of the UE), where the wake up radio receiver uses less power than the main radio of the UE (e.g., the first radio of the UE). The network entity may transmit a signal(s) for reception via the wake up radio of the UE that include system information such as synchronization or timing information that would be included in a master information block (MIB), a system information block (SIB), and/or a synchronization signal block (SSB), for example, in order to reduce latency associated with waking up the main radio from a sleep mode or in order to increase bandwidth and/or provide additional system information or more frequent system information to the UE.

A method for wireless communications at a UE is described. The method may include receiving, via a first radio of the UE, control signaling indicating one or more parameters associated with reception of signaling via a second radio of the UE, where the second radio is associated with a lower power consumption than the first radio and receiving, from a network entity via the second radio and in accordance with the one or more parameters, a signal indicating system information associated with the network entity.

An apparatus for wireless communications at a UE is described. The apparatus may include at least one processor and memory coupled with the at least one processor. The memory stores instructions for the at least one processor to cause the UE to receive, via a first radio of the UE, control signaling indicating one or more parameters associated with reception of signaling via a second radio of the UE, where the second radio is associated with a lower power consumption than the first radio and receive, from a network entity via the second radio and in accordance with the one or more parameters, a signal indicating system information associated with the network entity.

Another apparatus for wireless communications at a UE is described. The apparatus may include means for receiving, via a first radio of the UE, control signaling indicating one or more parameters associated with reception of signaling via a second radio of the UE, where the second radio is associated with a lower power consumption than the first radio and means for receiving, from a network entity via the second radio and in accordance with the one or more parameters, a signal indicating system information associated with the network entity.

A non-transitory computer-readable medium storing code for wireless communications at a UE is described. The code may include instructions executable by at least one processor (e.g., directly, indirectly, after pre-processing, without pre-processing) to receive, via a first radio of the UE, control signaling indicating one or more parameters associated with reception of signaling via a second radio of the UE, where the second radio is associated with a lower power consumption than the first radio and receive, from a network entity via the second radio and in accordance with the one or more parameters, a signal indicating system information associated with the network entity.

In some examples of the method, apparatuses, and non-transitory computer-readable medium described herein, receiving the signal indicating the system information may include operations, features, means, or instructions for receiving the signal indicating the system information including a subset of information associated with a SIB, a subset of information associated with a MIB, an indication of a time division duplexing (TDD) pattern for communication via the first radio, a slot format indicator for communication with the network entity via the first radio, or scheduling information for a radio resource management (RRM) measurement for the first radio.

In some examples of the method, apparatuses, and non-transitory computer-readable medium described herein, receiving the control signaling indicating the one or more parameters may include operations, features, means, or instructions for receiving the control signaling indicating the one or more parameters include a set of signal formats associated with a set of system information types, the signal having a signal format of the set of signal formats.

In some examples of the method, apparatuses, and non-transitory computer-readable medium described herein, receiving the signal may include operations, features, means, or instructions for receiving the signal via a reference signal resource or a synchronization signal resource.

In some examples of the method, apparatuses, and non-transitory computer-readable medium described herein, receiving the control signaling indicating the one or more parameters may include operations, features, means, or instructions for receiving the control signaling indicating the one or more parameters include a first format for SSBs associated with the second radio, a second format for SIBs associated with the second radio, a third format for channel state information reference signals (CSI-RSs) associated with the second radio, or a combination thereof, and where the signal includes one of an SSB in the first format, a SIB in the second format, or a CSI-RS in the third format.

In some examples of the method, apparatuses, and non-transitory computer-readable medium described herein, receiving the signal may include operations, features, means, or instructions for receiving the signal while the first radio may be in a sleep mode.

In some examples of the method, apparatuses, and non-transitory computer-readable medium described herein, receiving the signal may include operations, features, means, or instructions for receiving the signal while in communication with the network entity via the first radio.

Some examples of the method, apparatuses, and non-transitory computer-readable medium described herein may further include operations, features, means, or instructions for receiving, from the network entity via the second radio, a wake up signal (WUS) indicating a monitoring occasion for the signal, reception of the signal being via the monitoring occasion.

In some examples of the method, apparatuses, and non-transitory computer-readable medium described herein, receiving the WUS may include operations, features, means, or instructions for receiving the WUS including a flag indicating the monitoring occasion may be used for indicating the system information.

In some examples of the method, apparatuses, and non-transitory computer-readable medium described herein, a format of the WUS indicates that the monitoring occasion may be used for indicating the system information.

In some examples of the method, apparatuses, and non-transitory computer-readable medium described herein, receiving the signal may include operations, features, means, or instructions for receiving the signal indicating the system information including scheduling information for a second signal including additional system information for reception via the first radio, where the signal may be a WUS.

In some examples of the method, apparatuses, and non-transitory computer-readable medium described herein, receiving the signal indicating the system information may include operations, features, means, or instructions for receiving the signal indicating the system information including timing adjustment information for communication between the UE and the network entity via the first radio.

In some examples of the method, apparatuses, and non-transitory computer-readable medium described herein, the timing adjustment information includes a first timing parameter and one or more second timing parameters indicated as differential values with respect to the first timing parameter.

In some examples of the method, apparatuses, and non-transitory computer-readable medium described herein, receiving the control signaling indicating the one or more parameters may include operations, features, means, or instructions for receiving an indication of a duration in discontinuous reception (DRX) cycles for which the timing adjustment information may be applicable.

A method for wireless communications at a network entity is described. The method may include transmitting, to a UE, control signaling indicating one or more parameters associated with reception of signaling via a second radio of the UE, where the second radio is associated with a lower power consumption than a first radio of the UE and transmitting, to the UE in accordance with the one or more parameters, a signal indicating system information associated with the network entity.

An apparatus for wireless communications at a network entity is described. The apparatus may include at least one processor and memory coupled with the at least one processor. The memory stores instructions for the at least one processor to cause the network entity to transmit, to a UE, control signaling indicating one or more parameters associated with reception of signaling via a second radio of the UE, where the second radio is associated with a lower power consumption than a first radio of the UE and transmit, to the UE in accordance with the one or more parameters, a signal indicating system information associated with the network entity.

Another apparatus for wireless communications at a network entity is described. The apparatus may include means for transmitting, to a UE, control signaling indicating one or more parameters associated with reception of signaling via a second radio of the UE, where the second radio is associated with a lower power consumption than a first radio of the UE and means for transmitting, to the UE in accordance with the one or more parameters, a signal indicating system information associated with the network entity.

A non-transitory computer-readable medium storing code for wireless communications at a network entity is described. The code may include instructions executable by at least one processor (e.g., directly, indirectly, after pre-processing, without pre-processing) to transmit, to a UE, control signaling indicating one or more parameters associated with reception of signaling via a second radio of the UE, where the second radio is associated with a lower power consumption than a first radio of the UE and transmit, to the UE in accordance with the one or more parameters, a signal indicating system information associated with the network entity.

In some examples of the method, apparatuses, and non-transitory computer-readable medium described herein, transmitting the signal indicating the system information may include operations, features, means, or instructions for transmitting the signal indicating the system information including a subset of information associated with a SIB, a subset of information associated with a MIB, an indication of a TDD pattern for communication via the first radio, a slot format indicator for communication with the network entity via the first radio, or scheduling information for am RRM measurement for the first radio.

In some examples of the method, apparatuses, and non-transitory computer-readable medium described herein, transmitting the control signaling indicating the one or more parameters may include operations, features, means, or instructions for transmitting the control signaling indicating the one or more parameters include a set of signal formats associated with a set of system information types, the signal having a signal format of the set of signal formats.

In some examples of the method, apparatuses, and non-transitory computer-readable medium described herein, transmitting the signal may include operations, features, means, or instructions for transmitting the signal via a reference signal resource or a synchronization signal resource.

In some examples of the method, apparatuses, and non-transitory computer-readable medium described herein, transmitting the control signaling indicating the one or more parameters may include operations, features, means, or instructions for transmitting the control signaling indicating the one or more parameters include a first format for SSBs associated with the second radio, a second format for SIBs associated with the second radio, a third format for CSI-RSs associated with the second radio, or a combination thereof, and where the signal includes one of an SSB in the first format, a SIB in the second format, or a CSI-RS in the third format.

Some examples of the method, apparatuses, and non-transitory computer-readable medium described herein may further include operations, features, means, or instructions for transmitting, to the UE, a WUS indicating a monitoring occasion for the signal, transmission of the signal being via the monitoring occasion.

In some examples of the method, apparatuses, and non-transitory computer-readable medium described herein, transmitting the WUS may include operations, features, means, or instructions for transmitting the WUS including a flag indicating the monitoring occasion may be used for indicating the system information.

In some examples of the method, apparatuses, and non-transitory computer-readable medium described herein, a format of the WUS indicates that the monitoring occasion may be used for indicating the system information.

In some examples of the method, apparatuses, and non-transitory computer-readable medium described herein, transmitting the signal may include operations, features, means, or instructions for transmitting the signal indicating the system information including scheduling information for a second signal including additional system information for reception at the UE via the first radio, where the signal may be a WUS.

In some examples of the method, apparatuses, and non-transitory computer-readable medium described herein, transmitting the signal indicating the system information may include operations, features, means, or instructions for transmitting the signal indicating the system information including timing adjustment information for communication between the UE and the network entity via the first radio.

In some examples of the method, apparatuses, and non-transitory computer-readable medium described herein, the timing adjustment information includes a first timing parameter and one or more second timing parameters indicated as differential values with respect to the first timing parameter.

In some examples of the method, apparatuses, and non-transitory computer-readable medium described herein, transmitting the control signaling indicating the one or more parameters may include operations, features, means, or instructions for transmitting an indication of a duration in DRX cycles for which the timing adjustment information may be applicable.

### BRIEF DESCRIPTION OF THE DRAWINGS

FIG. 1 illustrates an example of a wireless communications system that supports receiving system information via wake up radio signals in accordance with one or more aspects of the present disclosure.

FIG. 2 illustrates an example of a block diagram of a user equipment (UE) that supports receiving system information via wake up radio signals in accordance with one or more aspects of the present disclosure.

FIG. 3 illustrates an example of a wireless communication system that supports receiving system information via wake up radio signals in accordance with one or more aspects of the present disclosure.

FIG. 4 illustrates an example of a timing diagram that supports receiving system information via wake up radio signals in accordance with one or more aspects of the present disclosure.

FIG. 5 illustrates an example of a process flow that supports receiving system information via wake up radio signals in accordance with one or more aspects of the present disclosure.

FIGS. 6 and 7 illustrate block diagrams of devices that support receiving system information via wake up radio signals in accordance with one or more aspects of the present disclosure.

FIG. 8 illustrates a block diagram of a communications manager that supports receiving system information via wake up radio signals in accordance with one or more aspects of the present disclosure.

FIG. 9 illustrates a diagram of a system including a device that supports receiving system information via wake up radio signals in accordance with one or more aspects of the present disclosure.

FIGS. 10 and 11 illustrate block diagrams of devices that support receiving system information via wake up radio signals in accordance with one or more aspects of the present disclosure.

FIG. 12 illustrates a block diagram of a communications manager that supports receiving system information via wake up radio signals in accordance with one or more aspects of the present disclosure.

FIG. 13 illustrates a diagram of a system including a device that supports receiving system information via wake up radio signals in accordance with one or more aspects of the present disclosure.

FIGS. 14 through 19 illustrate flowcharts showing methods that support receiving system information via wake up radio signals in accordance with one or more aspects of the present disclosure.

### DETAILED DESCRIPTION

Some user equipments (UE)s include a wake up radio (e.g., a second radio) in addition to a main radio (e.g., a first radio). The wake up radio may monitor for wake up signals (WUS)s, reference signals (for channel estimation), and/or synchronization signals (for synchronization) while the UE is in a sleep mode. The wake up radio receiver uses less power than the main radio, and accordingly inclusion of a wake up radio saves power at the UE when the UE is in a sleep mode. A network entity may wake up a UE via transmitting a WUS to the UE, and the UE subsequently may communicate with the network entity or via sidelink with another UE. Upon wake up of the main radio, the UE may receive a master information block (MIB), one or more system information blocks (SIBs), and/or synchronization signal blocks (SSBs) in order to synchronize the main radio of the UE with the network entity. Waiting for reception of the MIB, SIBs, and/or SSBs in order to receive the synchronization information may delay initiation of communications via the main radio of the UE after waking up from a sleep mode.

The network entity may transmit a signal(s) for reception via the wake up radio that includes system information such as synchronization or timing information that would be included in a MIB, SIB, and/or SSB. While the main radio of the UE is in a sleep mode, the UE may receive the signal that includes the system information via the wake up radio. Accordingly, upon wake up of the main radio, the UE may more quickly establish communications with the network via the main radio, as the UE may not be delayed by reception of the MIB, SIBs, and/or SSBs that includes the relevant synchronization or timing information. The network may indicate a configuration for (e.g., one or more parameters for) receiving system information via the wake up radio, and the UE may receive the signal(s) using the wake up radio in accordance with the configuration. For example, different signal formats may be used to indicate different types of information (e.g., information that would be transmitted in a MIB, a SIB1, a SIB2, or an SSB). The signals for reception via the wake up radio of the UE may be WUSs, reference signals (e.g., similar to channel state information (CSI) reference signals (CSI-RS) for the main radio), or SSBs. Additionally, or alternatively, the network may transmit system information to the UE via low power signals while the main radio of the UE is active (e.g., while the UE is communicating with the network via the main radio) in order to increase bandwidth and/or provide additional system information or more frequent system information to the UE.

Aspects of the disclosure are initially described in the context of wireless communications systems. Aspects of the disclosure are further illustrated by and described with reference to block diagrams, timing diagrams, and process flows. Aspects of the disclosure are further illustrated by and described with reference to apparatus diagrams, system diagrams, and flowcharts that relate to receiving system information via wake up radio signals.

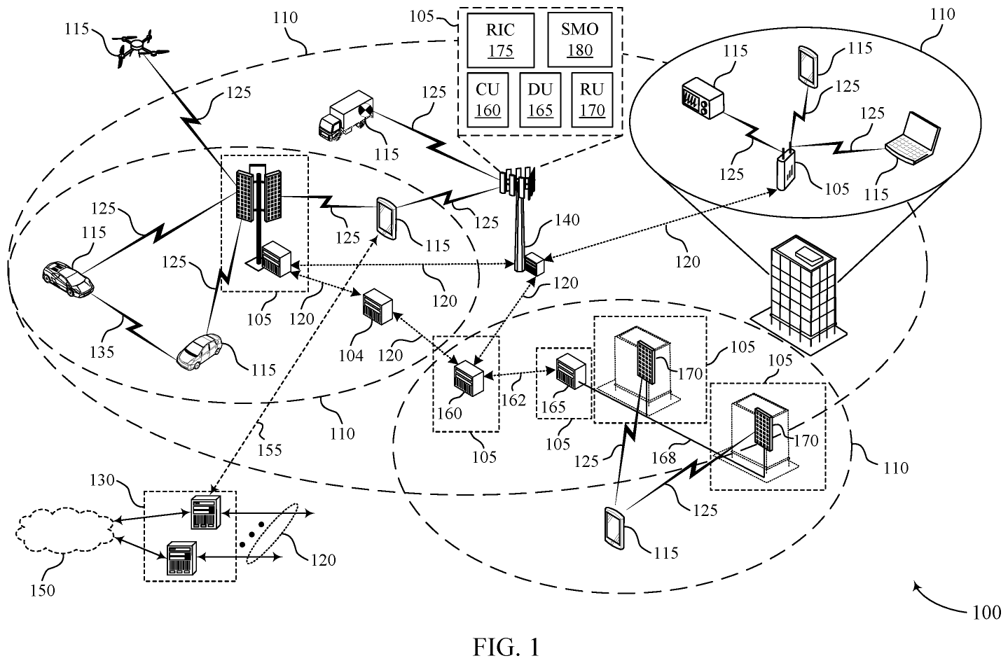

FIG. 1 illustrates an example of a wireless communications system 100 that supports receiving system information via wake up radio signals in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an TAB mobile termination (IAB-MT) controlled (e.g., scheduled) by DUs 165 of a coupled IAB donor. An TAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the TAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other TAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support receiving system information via wake up radio signals as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some UEs 115 include a wake up radio receiver (e.g., a second radio) in addition to a main radio (e.g., a first radio). The wake up radio may monitor for WUSs, reference signals (for channel estimation), and/or synchronization signals (for synchronization) while the UE 115 is in a sleep mode. The wake up radio uses less power than the main radio, and accordingly inclusion of a wake up radio saves power at the UE 115 when the UE 115 is in a sleep mode.

The network entity 105 may transmit a signal(s) for reception via the wake up radio that include system information such as synchronization or timing information that would be included in a MIB, SIB, and/or SSB, for example, in order to reduce latency associated with waking up the main radio from a sleep mode or in order to increase bandwidth and/or provide additional system information or more frequent system information to the UE 115. While the main radio of the UE 115 is in a sleep mode, the UE 115 may receive a signal that includes the system information via the wake up radio. Accordingly, upon wake up of the main radio, the UE 115 may more quickly establish communications with the network via the main radio, as the UE 115 may not be delayed by reception of the MIB, SIBs, and/or SSBs that includes the relevant synchronization or timing information. The network entity 105 may indicate a configuration for (e.g., one or more parameters for) receiving system information via the wake up radio, and the UE 115 may receive the signal(s) using the wake up radio in accordance with the configuration. For example, different signal formats may be used to indicate different types of information (e.g., information that would be transmitted in a MIB, a SIB1, a SIB2, or an SSB). The signals for reception via the wake up radio may be WUSs, reference signals (e.g., similar to CSI-RSs for the main radio), or SSBs. Additionally, or alternatively, the network entity 105 may transmit system information to the UE 115 via low power signals while the main radio of the UE 115 is active (e.g., while the UE 115 is communicating with the network entity 105 via the main radio) in order to increase bandwidth and/or provide additional system information or more frequent system information to the UE 115.

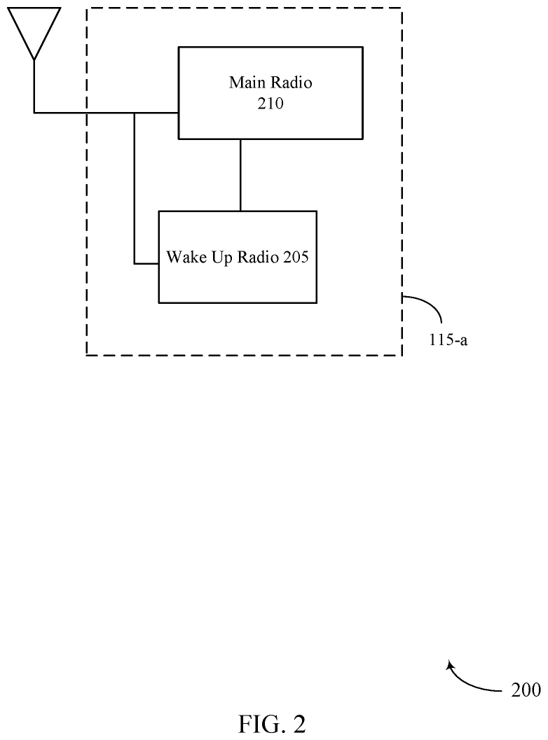

FIG. 2 illustrates an example of a block diagram 200 of a UE 115-a that supports receiving system information via wake up radio signals in accordance with one or more aspects of the present disclosure. The block diagram 200 may implement aspects of the wireless communication system 100. For example, the UE 115-a may be an example of a UE 115 as described herein.

The UE 115-a includes a wake up radio 205 in addition to a main radio 210. The wake up radio 205 may be a companion receiver that monitors for WUSs with low power consumption while the main radio 210 is in a sleep mode (e.g., a deep sleep state). The wake up radio 205 may be powered separately from the main radio 210 in order to consume less power than the main radio 210 (e.g., the wake up radio 205 may use less power hungry blocks). The wake up radio 205 may wake up the main radio 210 when data communication is demanded. Inclusion of a wake up radio 205 in a UE 115-a may reduce total power consumption at the UE 115-a by avoiding unnecessary wake up of the main radio 210, which uses more power than the wake up radio 205. Inclusion of the wake up radio 205 may also reduce latency by allowing for frequent monitoring of WUSs, thereby reducing average latency (e.g., as compared to periodic turning on of a main radio 210 in order to monitor for WUSs). As described herein, in some examples, a UE 115-a may be configured to monitor for system information associated with a network entity 105 via the wake up radio 205.

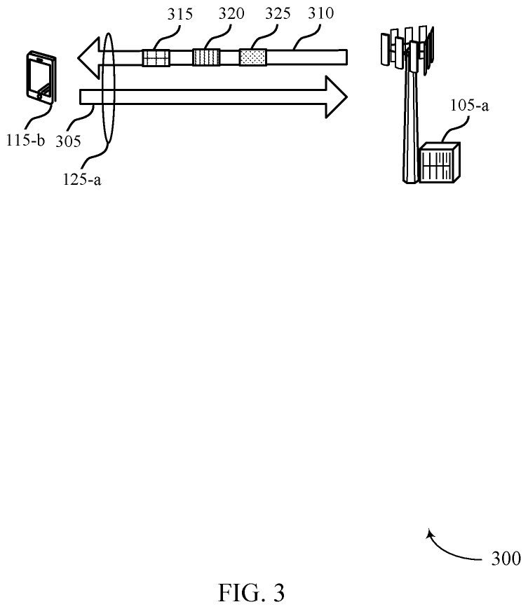

FIG. 3 illustrates an example of a wireless communications system 300 that supports receiving system information via wake up radio signals in accordance with one or more aspects of the present disclosure. In some examples, the wireless communications system 300 may be implemented by or may implement aspects of the wireless communications system 100 and/or the block diagram 200.

The network entity 105-a may communicate with the UE 115-b via a communication link 125-a, which may be an example of an NR or LTE link between the UE 115-b and the network entity 105-a. In some cases, the communication link 125-a may include an example of an access link (e.g., Uu link). The communication link 125-a may include a bi-directional link that enables both uplink and downlink communication. For example, the UE 115-b may transmit uplink signals 305, such as uplink control signals or uplink data signals, to the network entity 105-a using the communication link 125-a, and the network entity 105-a may transmit downlink signals 310, such as downlink control signals or downlink data signals, to the UE 115-b using the communication link 125-a.

In some examples, the UE 115-b may receive control signaling 315 from the network entity 105-a indicating one or more parameters (e.g., signal formats or timing information) associated with reception of signaling via a wake up radio of the UE 115-b. The UE 115-b may receive, from the network entity 105-a via the wake up radio of the UE 115-b, a signal 320 indicating system information associated with the network entity 105-b in accordance with the one or more parameters. For example, the system information conveyed in the signal 320 may include one or more of: a subset of information carrier by a MIB; a subset of information conveyed by a SIB (e.g., SIB1 or another SIB); timing information; a system TDD pattern (e.g., a TDD configuration or update) for communications via the main radio of the UE 115-b or for communications via the wake up radio (e.g., if the wake up radio has a different TDD pattern than the main radio); slot format indicator (SFI) control information for communications via the main radio (e.g., similar to SFI indicated in downlink control information (DCI)) or SFI control information for communications via the wake up radio in addition to an indication for the first slot type (downlink or uplink) after wake up (for the main radio) or starting of monitoring (for the wake up radio) or after a certain time from a low power signal or at the time of the signal 320; or an indication to perform a radio resource management (RRM) measurement by the main radio.

For example, system information that may be conveyed in a MIB, SIB1, or other SIBs that may be included in the signal 320 may include an indication to wake up the main radio to perform or relax or offload to the wake up radio RRM measurements (downlink, uplink, or both) in one or more DRX cycles or measurement times. Such an indication may also include at least one of a type of RRM (e.g., inter-frequency, intra-frequency, or both), and from which cells (e.g., serving cells, non-serving cells, or both). As another example, system information that may be conveyed in a MIB, SIB1, or other SIBs that may be included in the signal 320 may include the cell identifier (ID), a tracking area, or a RAN area ID. As another example, system information that may be conveyed in a MIB, SIB1, or other SIBs that may be included in the signal 320 may include earthquake or tsunami warning system (ETWS) bits, support of emergency calls, or any other information that may be conveyed in a MIB, SIB1, or other SIBs.

For example, SIB1 may include public land mobile network (PLMN) identify list, tracking area code (TAC), cell identity, barred/not barred indication, cell selection information, system information scheduling information, support for emergency indication, support for incident management system (IMS) voice call indication, timers, constants, or other barring information. SIB2 may include cell reselection information, SIB3 may include information regarding neighboring cells on the same frequency (e.g., for 5G), SIB4 may include information regarding neighboring cells on a different frequency (e.g., for 5G), SIB5 may include neighboring LTE cells, SIB6 and/or SIB7 may include ETWS information, SIB8 may include commercial mobile alert system (CMAS) information, and SIB9 may include global positioning system (GPS) and coordinated universal time (UTC) information.

For example, content conveyed in SIB1 includes: cell selection information, cell access related information, connection establishment failure control, system information scheduling information, serving cell common configuration, IMS emergency support flag, eCall over IMS support flag, UE-timer and UE-constants, unified access control (UAC) barring information, and use full resume ID flag. The cell selection information conveyed in SIB1 includes the parameters Q-RxLevMin, q-RxLevMinOffset, Q-RxLevMinSUL, Q-QualMin, and q-QualMinOfset. The SIB1 cell access related information contains PLMN information, TAC, RAN area code (RAC) and cell ID parameters. A SIB1 may broadcast cell access information for up to 12 PLMNs. The parameter trackingAreaCode in SIB1 may indicate the TAC to which the cell indicated by the parameter cellIdentity belongs. After acquisition of SIB1, if the trackingAreaCode (per PLMN) parameter is not present, the UE 115-b may consider a cell as barred. The parameter ranac may be used to identify a RAN area within the scope of a tracking are, and the RAN area code may be used when configuring a RAN notification area. The parameter CellIdentity may be used to identify a cell within a PLMN. The parameter cellReservedForOtherUse may indicate whether the cell is reserved, and the parameter may be applicable to all configured PLMNs. If a cell is reserved, camping may not be allowed except for specific UEs

As another example, a MIB may convey parameters such as systemFrameNumber, subCarrierSpacingCommon, ssb-subcarrierOfset, dmrs-TypeA-Position, pdcchConfigSIB1, cellBarred, and/or intraFreqReselection. NR communications may have a 10 bit SFN start from 0 to 1023, and a MIB may carry the 6 most significant bits (MSB)s of the 10 bits in the parameter systemFrameNumber, and the remaining 4 least significant bits (LSB)s of the SFN may be conveyed in the physical broadcast channel (PBCH) as part of channel coding (e.g., outside the MIB encoding). The parameter subCarrierSpacingCommon may indicate the subcarrier spacing for SIB1, message 2/4 for initial access, and system information messages. The parameter subCarrierSpacingCommon may have a value of 15 or 30 kHz valid for carrier frequencies less than 6 GHz, or values of 60 or 120 kHz applicable for carrier frequencies above 6 GHz. The parameter ssb-subcarrierOffset may indicate the frequency domain offset between SSB and the overall resource block grid in a number of subcarriers. The parameter ssb-subcarrierOfset may indicate that the cell does not provide SIB1 and that there is hence no common control resource set (CORESET). In the case the cell does not provide a SIB1, the field pdcch-ConfigSIB1 may indicate the frequency positions where the UE may (or may not) find a synchronization signal/PBCH with a CORESET and search space for SIB1. The parameter dmrs-TypeA-Position may indicate the position of the first downlink demodulation reference signal (DMRS), and may correspond to the layer 1 parameter DL-DMRS-typeA-pos. The parameter pdcchConfigSIB1 may correspond to the parameter RMSI-PDCCH-Config, and may determine a bandwidth for physical downlink control channel (PDCCH) or SIB, a common CORESET, a common search space, and PDCCH parameters. If the parameter ssb-SubcarrierOffset indicates that SIB1 is not present, the parameter pdcchConfigSIB1 may indicate the frequency positions where the UE may find a synchronization signal/PBCH with SIB1 or the frequency range where the network does not provide a synchronization signal/PBCH with SIB1. The parameter cellBarred indicates whether the cell allows UEs to camp on the cell. The parameter intraFreqReselection indicates if intra frequency cell reselection is allowed. The parameter intraFreqReselection controls cell reselection to intra-frequency cells when the highest ranked cell is barred, or treated as barred by the UE 115-b.

In some examples, the UE 115-b may be configured (through the main radio or the wake up radio) with different signal formats for reception of a signal 320 via the wake up radio, where different formats can have different contents of information. For example, the one or more parameters in the control signaling 315 may be the different signal formats. In some examples, the UE 115-b may be configured (through the main radio or the wake up radio) with different monitoring occasions for reception of a signal 320 via the wake up radio, where each monitoring occasion can have certain signal configuration and information content to receive combinations of system information. For example, the one or more parameters in the control signaling 315 may be the different monitoring occasions.

In some examples, the signal 320 may be a WUS or a reference signal for the wake up radio (e.g., may cover one or more stages of a WUS or a reference signal). In some examples, a reference signal for the wake up radio may include one or more reference signal resources or resource sets used for channel tracking (e.g., similar to sounding reference signal (SRS) and/or CSI-RS for the main radio) and/or synchronization signal resources or resource sets (e.g., similar to SSBs for the main radio). In some examples, the wake up radio of the UE may process SSBs, SIBs, and/or CSI-RSs that convey the same information as SSBs, SIBs, and/or CSI-RSs for a main radio, but with a dedicated wake up radio configuration (e.g., in accordance with the one or more parameters indicated in the control signaling 315).

In some examples, as described herein, the wake up radio may monitor for the signal 320 in accordance with the control signaling 315 when the main radio is in a sleep mode. In some examples, as described herein, the wake up radio may monitor for the signal 320 in accordance with the control signaling 315 while the UE 115-b communicates with the network entity 105-a via the main radio (e.g., during certain time/frequency occasions that could be on the same or different frequency bands as communications via the main radio), for example in order to increase bandwidth and/or provide additional system information or more frequent system information to the UE 115-b.

In some examples, timing information provided in the signal 320 may include jitter statistic information (e.g., range (min, mac) of jitter, mean, variance, or distribution type). For example, such timing information may be used to reduce jitter by implementing dense monitoring around the center of a PDCCH occasion and sparse monitoring around the tails of the distribution. In some examples, timing information provided in the signal 320 may include a starting PDCCH monitoring occasion or paging monitoring occasions. In some examples, timing information provided in the signal 320 may include connected mode discontinuous reception (C-DRX), idle mode discontinuous reception (I-DRX), or enhanced discontinuous reception (eDRX) adjustment information (e.g., an adjustment of configuration/cycle or active time versus inactive time for the discontinuous reception (DRX) cycle).

For example, in the idle/inactive mode, the network entity 105-a may indicate via the signal 320 the frame index and slot index of the current signal 320 (e.g., which may be a WUS or reference signal), when the UE 115-b wakes up (e.g., after a given period of time for tuning hardware at the UE 115-b), or after a given period of time from the signal 320.

As another example, in the idle/inactive mode, the network entity 105-a may indicate via the signal 320 the exact time of a next (first available) SSB (or an SSB that was used by UE 115-b before going to sleep or before using the wake up radio for monitoring or an SSB that the network entity 105-a indicated to the UE 115-b to monitor) or a synchronization signal or beam management signal (e.g., a CSI-RS) that was configured for the main radio (e.g., before UE 115-b starts to monitor for signals via the wake up radio) relative to current received signal timing or relative to a reference time. Such an SSB may be connected to the latest observed or selected SSB by the UE 115-b as a corresponding beam (which may be known to the network entity 105-a).

As another example, in the idle/inactive mode, the network entity 105-a may indicate via the signal 320 the next random access channel (RACH) timing. As another example, in the idle/inactive mode, the network entity 105-a may indicate via the signal 320 the configuration of SIB1 reception using the main radio or the wake up radio, or the network entity 105-a may transmit a SIB1 for reception via the wake up radio (or a configuration to receive a PDCCH (e.g., via CORESET 0) which the UE then uses the main radio or wake up radio to receive SIB1 information), and timing information for reception of the SIB1 may be relative to a WUS reception time or relative to another reference timing for reception of another signal via the wake up radio.

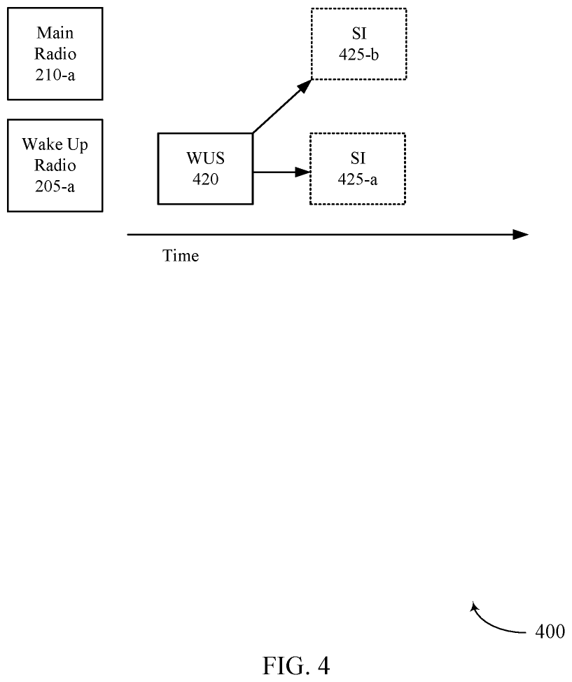

In some examples, as described with reference to FIG. 4, the signal 320 may be a WUS that indicates a monitoring occasion for the UE 115-b to receive a second signal 325 that includes additional system information. The UE 115-b may receive the second signal 325 via the wake up radio (e.g., mode 1) or the main radio (e.g., mode 2) of the UE 115-b. In some examples, a WUS monitoring occasion may be tied to a main radio monitoring occasion in order for the UE 115-b to receive additional system information. For example, there may be multiple monitoring (or different monitoring occasions) for different combinations of system information. In some examples, the WUS (e.g., the signal 320) may be used to indicate which occasion will be used for the main radio to receive a second signal 325 than includes additional system information. In some examples, the WUS (e.g., the signal 320) may indicate a time offset or a configuration to receive the system information in a second signal 325. In some examples, if system information is to be received by the wake up radio (e.g., the UE 115-b receives a second signal 325 that includes system information), UE 115-b may receive the second signal 325 in dedicated WUS or a dedicated monitoring occasion. In some examples, layer 1, layer 2, or layer 3 signaling dedicated for either the main radio of the UE 115-b or the wake up radio may configure the mode (e.g., mode 1 or mode 2). In some examples, mixed types of signaling across the radios (the wake up radio and the main radio) may be used. For example, signaling for the wake up radio may be used to wake up the main radio, and then system information may be indicated in layer 1, layer 2, or layer 3 signaling dedicated for either the wake up radio or the main radio. In some examples, the network entity 105-a may configure the UE 115-b with mode 1 or mode 2 via wake up radio signaling. For example, the wake up radio signaling may use OFDM-based on-off keying (OOK), the wake up radio signaling may be PDCCH based (e.g., similar to DCI using polar coding), or the wake up radio signaling may be a sequence based signal.

In some examples, the signal 320 may be a WUS and may indicate whether there is a second stage or multiple stages (e.g., one or more second signals 325) carrying the system information. In some examples, a signal for reception via the main radio may be used to carry the second/multiple stages carrying the system information. In some examples, a signal for reception via the wake up radio may be used to carry the second/multiple stages carrying the system information. In some examples, the signal 320 may be a WUS and may indicate an allocation or time/frequency allocation of the second stage (e.g., if not semi-statically configured). In some cases, the WUS may include a new or updated information flag that indicates whether to monitor or skip monitoring for the second stage (e.g., a “1” indicates a second stage carries system information and a “0” indicates the second stage does not carry system information.)

In some examples, the format of the WUS (e.g., the signal 320) may indicate which type of information may transmitted in a next one or more second signals 325 for reception via the wake up radio. For example, the format may include payload bits that indicate the format, a radio network temporary identifier (RNTI) or scrambling ID of the WUS, or a combination thereof. A time offset between the signal 320 and the one or more second signals 325 may be used as a guard to improve reliability, and may be based on a capability of the UE 115-b. In some examples, multi-stage system information signaling may be associated with the signaling format. For example, some formats may use single stages and some may use multiple stages, each format may involve different types of information, and the format used may be indicated. The formats may be configured via layer 1, layer 2, or layer 3 signaling via the main radio or the wake up radio. The configuration may include the meaning of the bits of the signals and which signals the UE 115-b is expected to monitor. In some examples, the configuration may be predefined (e.g., standardized). For example, format “0” may include one or more information elements of timing information and ETWS bits.

In some examples, as described herein, the signal 320 may include system information including timing information for communications between the UE 115-b and the network entity 105-a. In some examples, the timing information, if more than one timing parameter is provided, may be indicated as a first timing value, and then differential values (from a reference value) with a quantization codebook or tables may be predefined (e.g., standardized) or signaled via layer 1, layer 2, or layer 3 signaling (e.g., DCI, a MAC control element (MAC-CE), or RRC). In some examples, the timing adjustment information may be valid for more than one DRX cycle (e.g., C-DRX, I-DRX, or eDRX cycle), and accordingly a validity timer expressed in a quantity of DRX cycles may be indicated in the signal 320. In some examples, the timing information may be a delta indication of an offset from a last timing indication (e.g., at time t, a jitter of Q(X) may be indicated, then at time t2 if the jitter is Q(Y), then Q(Y−X) may be indicated, where Q( ) is a quantization function). In some examples, the configuration of the delta/time offset may be configured via RRC signaling or a MAC-CE or a signal received by the UE 115-b via the wake up radio.

In some examples, the one or more parameters associated with reception of signaling via the wake up radio may include a configuration for receiving signals from one or more neighboring cells, including the band, frequency range, or BWP used to transmit the signaling from the one or more neighboring cells. The configuration for receiving signals from one or more neighboring cells via the wake up radio may be preconfigured or may be configured by the serving cell (e.g., associated with the serving network entity 105-a). In some examples, the configuration for receiving signals from one or more neighboring cells via the wake up radio may be determined partially or fully by the main radio of the UE 115-b through MIB, SIB1, other SIBs, or RACH messages with the at least one or more neighboring cells. The configuration for receiving signals from one or more neighboring cells may be different for inactive, idle, and active/connected RRC modes for the UE 115-b. Updates to the configuration for receiving signals from one or more neighboring cells via the wake up radio may be delivered to or determined at the UE 115-b during any RRC state for the UE 115-b via signaling from the serving cell or through MIB, SIB1, other SIBs, or RACH messages or through a combination of signaling and decoding.

In some examples, RRM measurements offloaded to the wake up radio for the serving cell or for one or more neighboring cells and the thresholds and configurations of components of the RRM measurements may be either signaled to the UE 115-b from the serving cell (for both the serving cell and neighboring cells) or may be determined partially or fully by the main radio of the UE 115-b through MIB, SIB1, other SIBs, or RACH messages or through a combination of signaling and decoding. Updates to RRM measurements may be delivered to or determined at the UE 115-b during any RRC state for the UE 115-b via signaling from the serving cell or through MIB, SIB1, other SIBs, or RACH messages or through a combination of signaling and decoding.

FIG. 4 illustrates an example of a timing diagram 400 that supports receiving system information via wake up radio signals in accordance with one or more aspects of the present disclosure. In some examples, the timing diagram 400 may be implemented by or may implement aspects of the wireless communications system 100, the block diagram 200, and/or the wireless communications system 300. For example, the timing diagram 400 may be implemented by a UE 115 that includes a main radio 210-a and a wake up radio 205-a.

As described with reference to FIG. 3, in some examples, a network entity 105 may transmit a WUS 420 that indicates a monitoring occasion for the UE 115 to receive a second signal 425 that includes additional system information. The WUS may be received by the wake up radio 205-a. In some examples (e.g., mode 1), the WUS may indicate a monitoring occasion for the UE 115 to receive the signal 425-a via the wake up radio 205-a. In some examples (e.g., mode 2), the WUS may indicate a monitoring occasion for the UE 115 to receive the signal 425-b via the main radio 210-a.

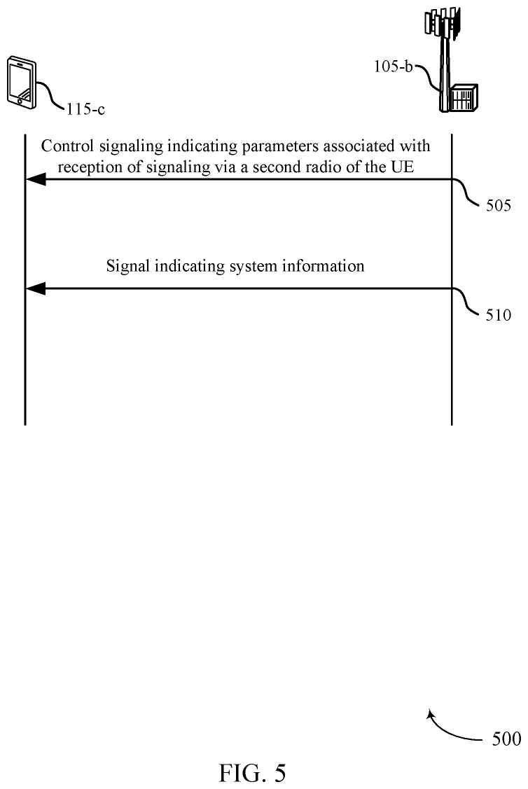

FIG. 5 illustrates an example of a process flow 500 that supports receiving system information via wake up radio signals in accordance with one or more aspects of the present disclosure. In some examples, aspects of the process flow 500 may implement, or be implemented by, aspects of wireless communications systems 100, the block diagram 200, the wireless communications system 300, the timing diagram 400, or any combination thereof.

The process flow 500 includes a UE 115-c and a network entity 105-b, which may be examples of a UE 115 and a network entity 105 as described herein. In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-c may receive, from the network entity 105-b and via a first radio of the UE 115-c (e.g., a main radio of the UE 115-c), one or more parameters associated with reception of signaling via a second radio of the UE 115-c (e.g., a wake up radio of the UE 115-c). The second radio of the UE 115-c is associated with a lower power consumption than the first radio of the UE 115-c.

At 510, the UE 115-c may receive, from the network entity 105-b via the second radio of the UE 115-c and in accordance with the one or more parameters, a signal indicating system information associated with the network entity 105-b. In some examples, the signal is received via a reference signal resource or a synchronization signal resource.

In some examples, the signal indicating system information may include a subset of information associated with a SIB, a subset of information associated with a MIB, an indication of a TDD pattern for communication via the first radio, an SFI for communication with the network entity 105-b via the first radio, or scheduling information for an RRM measurement for the first radio.

In some examples, the one or more parameters include a set of signal formats associated with a set of system information types, and the signal received at 510 has a signal format of the set of signal formats. In some examples, the one or more parameters include a first format for SSBs associated with the second radio, a second format for SIBs associated with the second radio, a third format for CSI-RSs associated with the second radio, or a combination thereof, and the signal received at 510 is an SSB in the first format, a SIB in the second format, or a CSI-RS in the third format.

In some examples, the UE 115-c may receive the signal at 510 while the first radio of the UE 115-c is in a sleep mode. In some examples, the UE 115-c may receive the signal at 510 while the UE 115-c is in communication with the network entity 105-b via the first radio of the UE 115-c.

In some examples, the UE 115-c may receive, from the network entity 105-b, a WUS indicating a monitoring occasion for the signal, and the UE 115-c may receive the signal via the indicated monitoring occasion. In some examples, the WUS main include a flag indicating the monitoring occasion is used to transmit system information. In some examples, a format of the WUS indicates that the monitoring occasion is used for indicating the system information.

In some examples, the signal received at 510 may include scheduling information for a second signal that includes additional system information for reception via the first radio, and the signal received at 510 may be a WUS.

In some examples, the signal received at 510 may include system information including timing adjustment information for communication between the UE 115-c and the network entity 105-b via the first radio of the UE 115-c. In some examples, the timing adjustment information may include a first timing parameter and one or more second timing parameters indicated as differential values with respect to the first timing parameter. In some examples, the one or more parameters indicated in the control signaling at 505 may include an indication of a duration in DRX cycles for which the timing adjustment information is applicable.

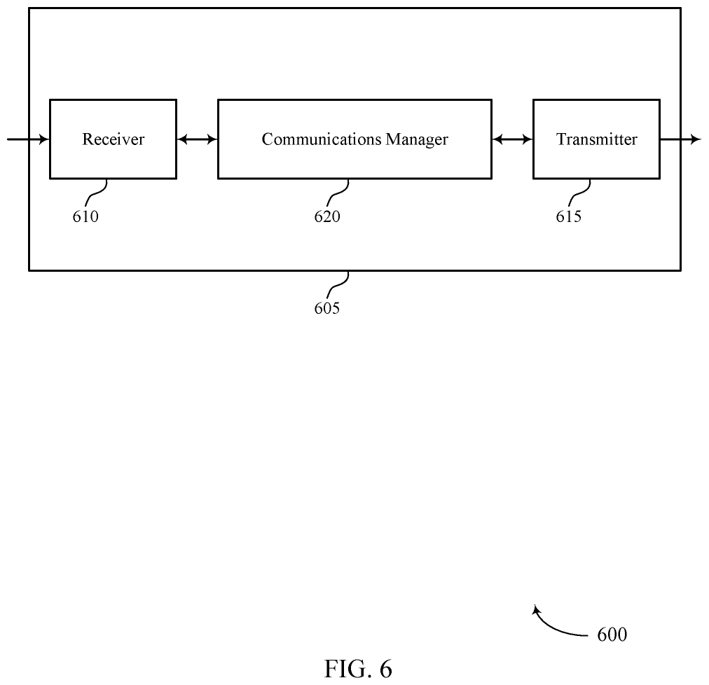

FIG. 6 illustrates a block diagram 600 of a device 605 that supports receiving system information via wake up radio signals in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to receiving system information via wake up radio signals). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to receiving system information via wake up radio signals). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of receiving system information via wake up radio signals as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving, via a first radio of the UE, control signaling indicating one or more parameters associated with reception of signaling via a second radio of the UE, where the second radio is associated with a lower power consumption than the first radio. The communications manager 620 may be configured as or otherwise support a means for receiving, from a network entity via the second radio and in accordance with the one or more parameters, a signal indicating system information associated with the network entity.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption and more efficient utilization of communication resource.

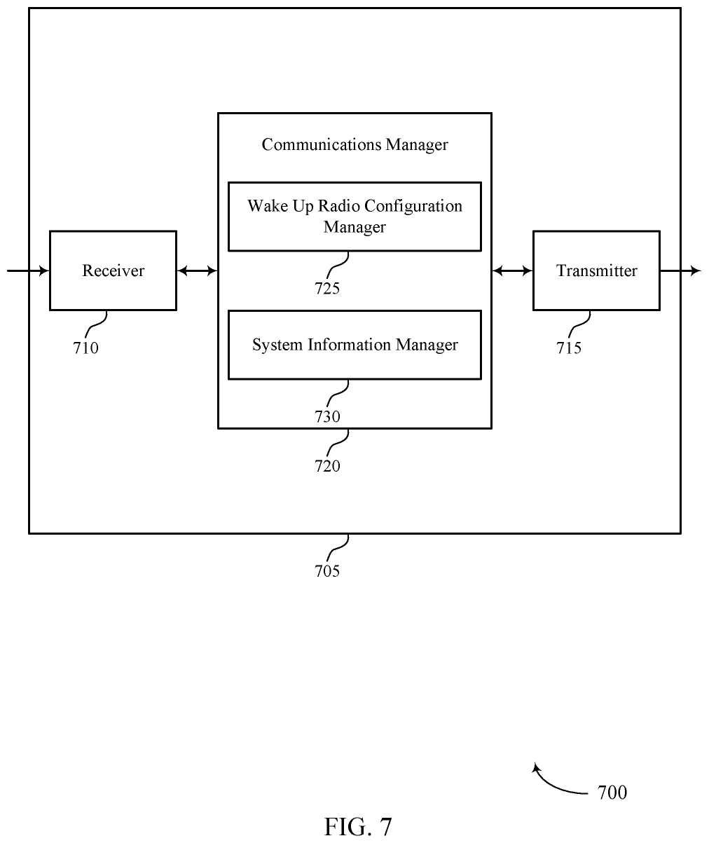

FIG. 7 illustrates a block diagram 700 of a device 705 that supports receiving system information via wake up radio signals in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to receiving system information via wake up radio signals). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to receiving system information via wake up radio signals). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of receiving system information via wake up radio signals as described herein. For example, the communications manager 720 may include a wake up radio configuration manager 725 a system information manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The wake up radio configuration manager 725 may be configured as or otherwise support a means for receiving, via a first radio of the UE, control signaling indicating one or more parameters associated with reception of signaling via a second radio of the UE, where the second radio is associated with a lower power consumption than the first radio. The system information manager 730 may be configured as or otherwise support a means for receiving, from a network entity via the second radio and in accordance with the one or more parameters, a signal indicating system information associated with the network entity.

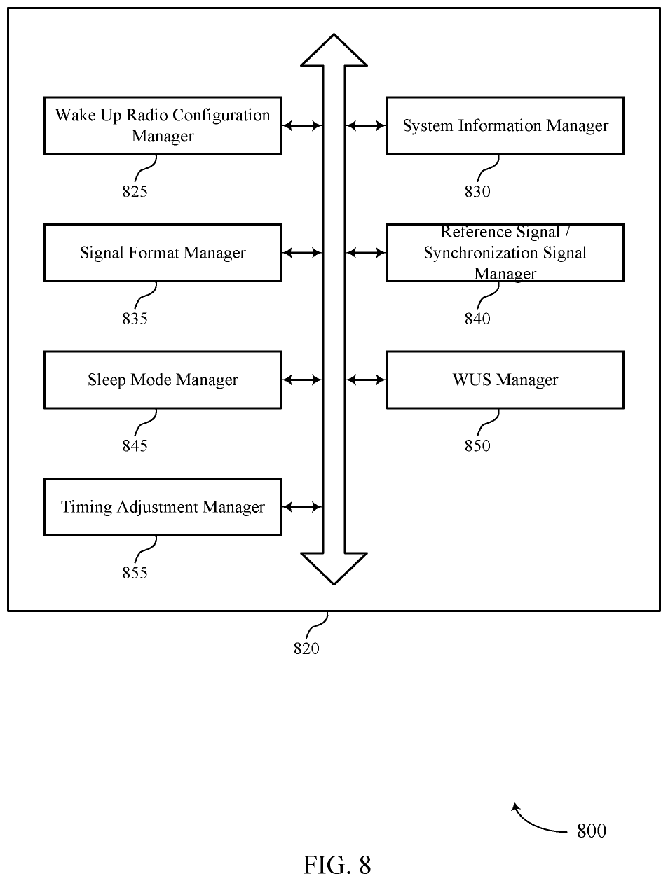

FIG. 8 illustrates a block diagram 800 of a communications manager 820 that supports receiving system information via wake up radio signals in accordance with one or more aspects of the present disclosure. The communications manager 820 may be an example of aspects of a communications manager 620, a communications manager 720, or both, as described herein. The communications manager 820, or various components thereof, may be an example of means for performing various aspects of receiving system information via wake up radio signals as described herein. For example, the communications manager 820 may include a wake up radio configuration manager 825, a system information manager 830, a signal format manager 835, a reference signal/synchronization signal manager 840, a sleep mode manager 845, a WUS manager 850, a timing adjustment manager 855, or any combination thereof. Each of these components may communicate, directly or indirectly, with one another (e.g., via one or more buses).

The communications manager 820 may support wireless communications at a UE in accordance with examples as disclosed herein. The wake up radio configuration manager 825 may be configured as or otherwise support a means for receiving, via a first radio of the UE, control signaling indicating one or more parameters associated with reception of signaling via a second radio of the UE, where the second radio is associated with a lower power consumption than the first radio. The system information manager 830 may be configured as or otherwise support a means for receiving, from a network entity via the second radio and in accordance with the one or more parameters, a signal indicating system information associated with the network entity.

In some examples, to support receiving the signal indicating the system information, the system information manager 830 may be configured as or otherwise support a means for receiving the signal indicating the system information including a subset of information associated with a SIB, a subset of information associated with a MIB, an indication of a TDD pattern for communication via the first radio, an SFI for communication with the network entity via the first radio, or scheduling information for an RRM measurement for the first radio.

In some examples, to support receiving the control signaling indicating the one or more parameters, the signal format manager 835 may be configured as or otherwise support a means for receiving the control signaling indicating the one or more parameters include a set of signal formats associated with a set of system information types, the signal having a signal format of the set of signal formats.

In some examples, to support receiving the signal, the reference signal/synchronization signal manager 840 may be configured as or otherwise support a means for receiving the signal via a reference signal resource or a synchronization signal resource.

In some examples, to support receiving the control signaling indicating the one or more parameters, the signal format manager 835 may be configured as or otherwise support a means for receiving the control signaling indicating the one or more parameters include a first format for SSBs associated with the second radio, a second format for SIBs associated with the second radio, a third format for CSI-RSs associated with the second radio, or a combination thereof, and where the signal includes one of an SSB in the first format, a SIB in the second format, or a CSI-RS in the third format.

In some examples, to support receiving the signal, the sleep mode manager 845 may be configured as or otherwise support a means for receiving the signal while the first radio is in a sleep mode.

In some examples, to support receiving the signal, the system information manager 830 may be configured as or otherwise support a means for receiving the signal while in communication with the network entity via the first radio.

In some examples, the WUS manager 850 may be configured as or otherwise support a means for receiving, from the network entity via the second radio, a WUS indicating a monitoring occasion for the signal, reception of the signal being via the monitoring occasion.

In some examples, to support receiving the WUS, the WUS manager 850 may be configured as or otherwise support a means for receiving the WUS including a flag indicating the monitoring occasion is used for indicating the system information.

In some examples, a format of the WUS indicates that the monitoring occasion is used for indicating the system information.

In some examples, to support receiving the signal, the WUS manager 850 may be configured as or otherwise support a means for receiving the signal indicating the system information including scheduling information for a second signal including additional system information for reception via the first radio, where the signal is a WUS.

In some examples, to support receiving the signal indicating the system information, the timing adjustment manager 855 may be configured as or otherwise support a means for receiving the signal indicating the system information including timing adjustment information for communication between the UE and the network entity via the first radio.

In some examples, the timing adjustment information includes a first timing parameter and one or more second timing parameters indicated as differential values with respect to the first timing parameter.

In some examples, to support receiving the control signaling indicating the one or more parameters, the timing adjustment manager 855 may be configured as or otherwise support a means for receiving an indication of a duration in DRX cycles for which the timing adjustment information is applicable.

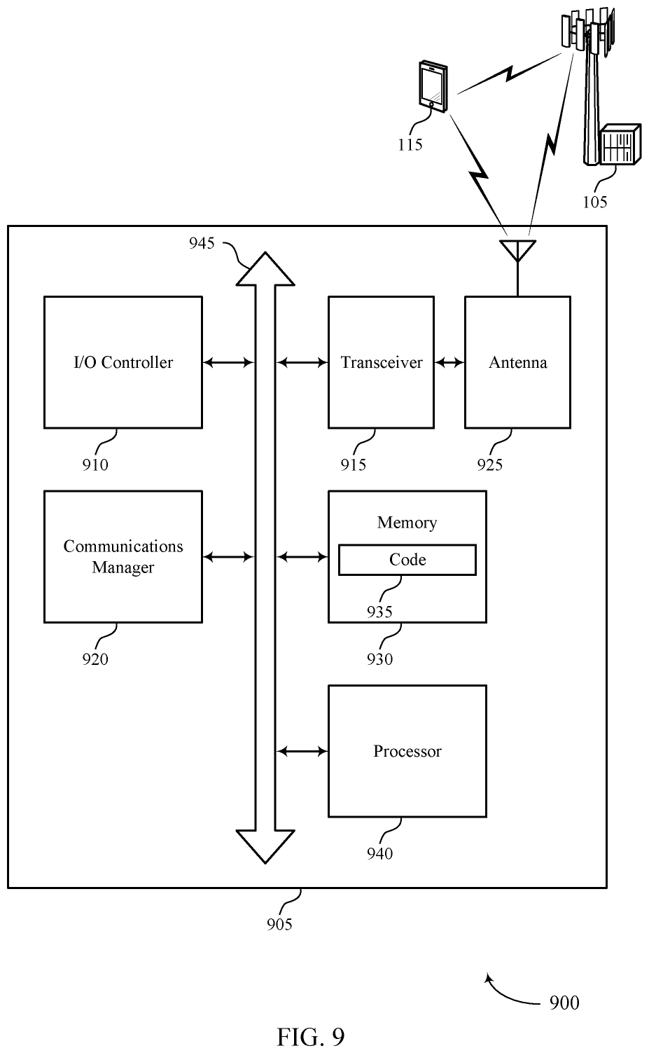

FIG. 9 illustrates a diagram of a system 900 including a device 905 that supports receiving system information via wake up radio signals in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting receiving system information via wake up radio signals). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, via a first radio of the UE, control signaling indicating one or more parameters associated with reception of signaling via a second radio of the UE, where the second radio is associated with a lower power consumption than the first radio. The communications manager 920 may be configured as or otherwise support a means for receiving, from a network entity via the second radio and in accordance with the one or more parameters, a signal indicating system information associated with the network entity.

By including or configuring the communications manager 920 in accordance with examples as described herein, the device 905 may support techniques for reduced latency, reduced power consumption, more efficient utilization of communication resources, improved coordination between devices, and longer battery life.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of receiving system information via wake up radio signals as described herein, or the processor 940 and the memory 930 may be otherwise configured to perform or support such operations.

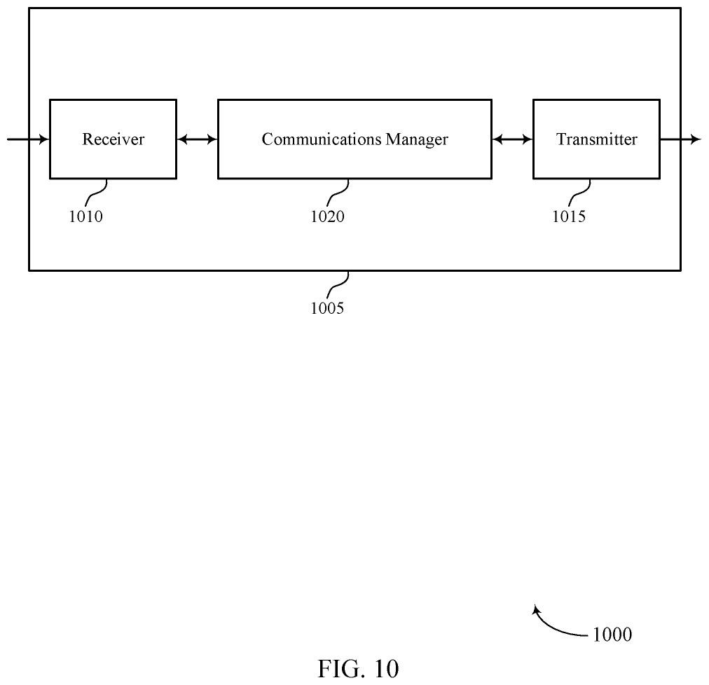

FIG. 10 illustrates a block diagram 1000 of a device 1005 that supports receiving system information via wake up radio signals in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of receiving system information via wake up radio signals as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for transmitting, to a UE, control signaling indicating one or more parameters associated with reception of signaling via a second radio of the UE, where the second radio is associated with a lower power consumption than a first radio of the UE. The communications manager 1020 may be configured as or otherwise support a means for transmitting, to the UE in accordance with the one or more parameters, a signal indicating system information associated with the network entity.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption and more efficient utilization of communication resource.

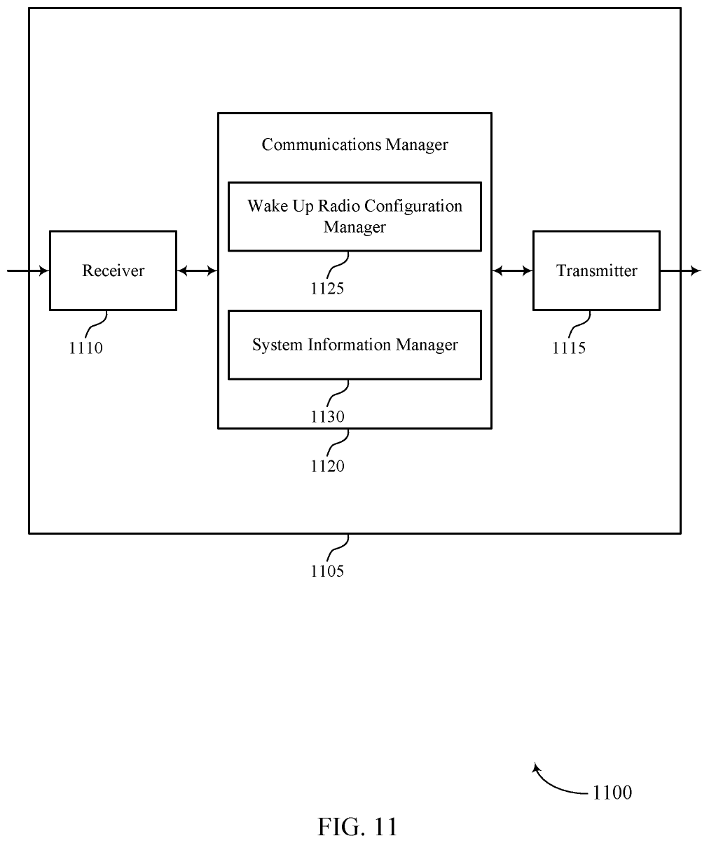

FIG. 11 illustrates a block diagram 1100 of a device 1105 that supports receiving system information via wake up radio signals in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of receiving system information via wake up radio signals as described herein. For example, the communications manager 1120 may include a wake up radio configuration manager 1125 a system information manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The wake up radio configuration manager 1125 may be configured as or otherwise support a means for transmitting, to a UE, control signaling indicating one or more parameters associated with reception of signaling via a second radio of the UE, where the second radio is associated with a lower power consumption than a first radio of the UE. The system information manager 1130 may be configured as or otherwise support a means for transmitting, to the UE in accordance with the one or more parameters, a signal indicating system information associated with the network entity.

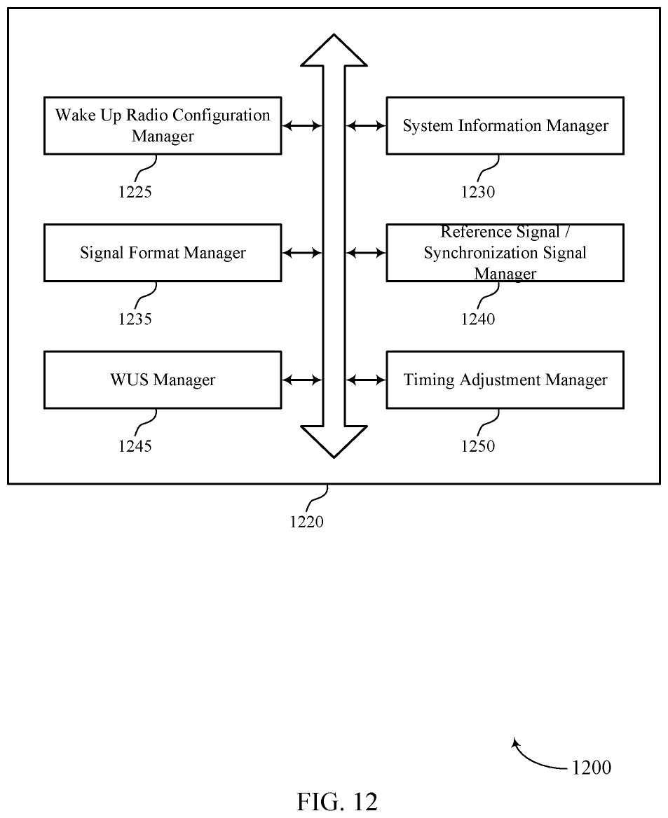

FIG. 12 illustrates a block diagram 1200 of a communications manager 1220 that supports receiving system information via wake up radio signals in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of receiving system information via wake up radio signals as described herein. For example, the communications manager 1220 may include a wake up radio configuration manager 1225, a system information manager 1230, a signal format manager 1235, a reference signal/synchronization signal manager 1240, a WUS manager 1245, a timing adjustment manager 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The wake up radio configuration manager 1225 may be configured as or otherwise support a means for transmitting, to a UE, control signaling indicating one or more parameters associated with reception of signaling via a second radio of the UE, where the second radio is associated with a lower power consumption than a first radio of the UE. The system information manager 1230 may be configured as or otherwise support a means for transmitting, to the UE in accordance with the one or more parameters, a signal indicating system information associated with the network entity.

In some examples, to support transmitting the signal indicating the system information, the system information manager 1230 may be configured as or otherwise support a means for transmitting the signal indicating the system information including a subset of information associated with a SIB, a subset of information associated with a MIB, an indication of a TDD pattern for communication via the first radio, an SFI for communication with the network entity via the first radio, or scheduling information for an RRM measurement for the first radio.

In some examples, to support transmitting the control signaling indicating the one or more parameters, the signal format manager 1235 may be configured as or otherwise support a means for transmitting the control signaling indicating the one or more parameters include a set of signal formats associated with a set of system information types, the signal having a signal format of the set of signal formats.

In some examples, to support transmitting the signal, the reference signal/synchronization signal manager 1240 may be configured as or otherwise support a means for transmitting the signal via a reference signal resource or a synchronization signal resource.

In some examples, to support transmitting the control signaling indicating the one or more parameters, the signal format manager 1235 may be configured as or otherwise support a means for transmitting the control signaling indicating the one or more parameters include a first format for SSBs associated with the second radio, a second format for SIBs associated with the second radio, a third format for CSI-RSs associated with the second radio, or a combination thereof, and where the signal includes one of an SSB in the first format, a SIB in the second format, or a CSI-RS in the third format.

In some examples, the WUS manager 1245 may be configured as or otherwise support a means for transmitting, to the UE, a WUS indicating a monitoring occasion for the signal, transmission of the signal being via the monitoring occasion.

In some examples, to support transmitting the WUS, the WUS manager 1245 may be configured as or otherwise support a means for transmitting the WUS including a flag indicating the monitoring occasion is used for indicating the system information.

In some examples, a format of the WUS indicates that the monitoring occasion is used for indicating the system information.

In some examples, to support transmitting the signal, the WUS manager 1245 may be configured as or otherwise support a means for transmitting the signal indicating the system information including scheduling information for a second signal including additional system information for reception at the UE via the first radio, where the signal is a WUS.

In some examples, to support transmitting the signal indicating the system information, the timing adjustment manager 1250 may be configured as or otherwise support a means for transmitting the signal indicating the system information including timing adjustment information for communication between the UE and the network entity via the first radio.

In some examples, the timing adjustment information includes a first timing parameter and one or more second timing parameters indicated as differential values with respect to the first timing parameter.

In some examples, to support transmitting the control signaling indicating the one or more parameters, the timing adjustment manager 1250 may be configured as or otherwise support a means for transmitting an indication of a duration in DRX cycles for which the timing adjustment information is applicable.

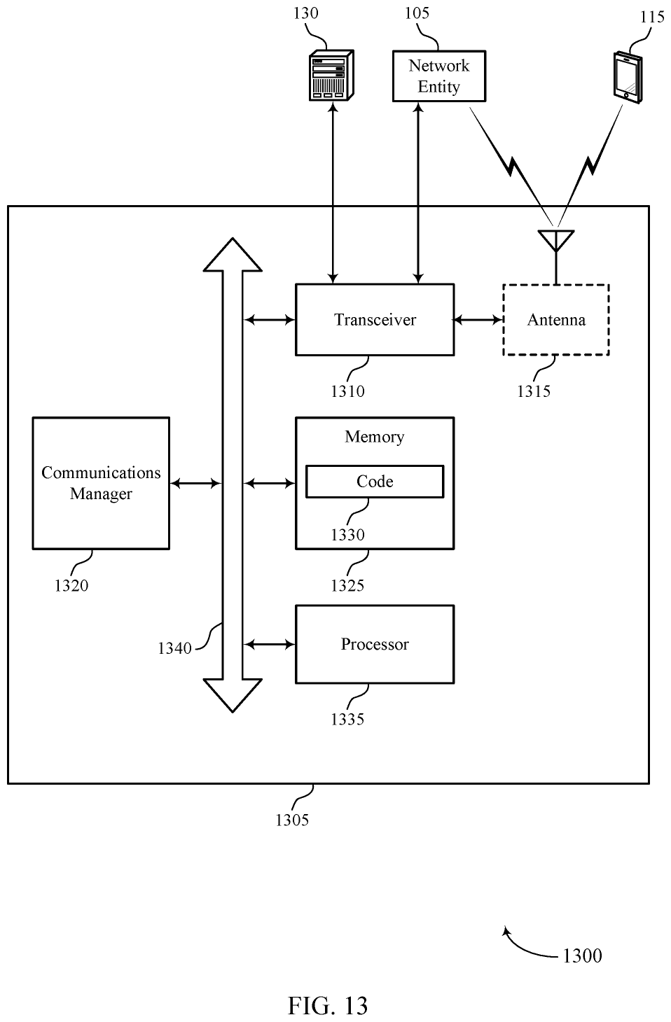

FIG. 13 illustrates a diagram of a system 1300 including a device 1305 that supports receiving system information via wake up radio signals in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting receiving system information via wake up radio signals). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for transmitting, to a UE, control signaling indicating one or more parameters associated with reception of signaling via a second radio of the UE, where the second radio is associated with a lower power consumption than a first radio of the UE. The communications manager 1320 may be configured as or otherwise support a means for transmitting, to the UE in accordance with the one or more parameters, a signal indicating system information associated with the network entity.

By including or configuring the communications manager 1320 in accordance with examples as described herein, the device 1305 may support techniques for reduced latency, reduced power consumption, more efficient utilization of communication resources, improved coordination between devices, and longer battery life.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of receiving system information via wake up radio signals as described herein, or the processor 1335 and the memory 1325 may be otherwise configured to perform or support such operations.

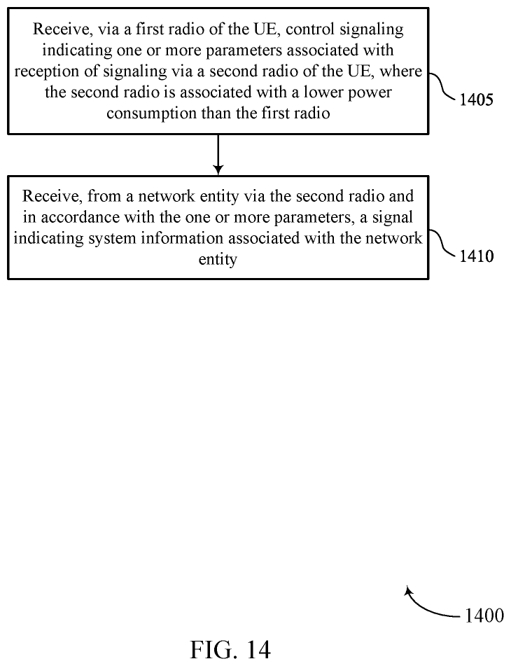

FIG. 14 illustrates a flowchart showing a method 1400 that supports receiving system information via wake up radio signals in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, via a first radio of the UE, control signaling indicating one or more parameters associated with reception of signaling via a second radio of the UE, where the second radio is associated with a lower power consumption than the first radio. The operations of 1405 may be performed in accordance with examples as disclosed herein. In some examples, aspects of the operations of 1405 may be performed by a wake up radio configuration manager 825 as described with reference to FIG. 8.

At 1410, the method may include receiving, from a network entity via the second radio and in accordance with the one or more parameters, a signal indicating system information associated with the network entity. The operations of 1410 may be performed in accordance with examples as disclosed herein. In some examples, aspects of the operations of 1410 may be performed by a system information manager 830 as described with reference to FIG. 8.

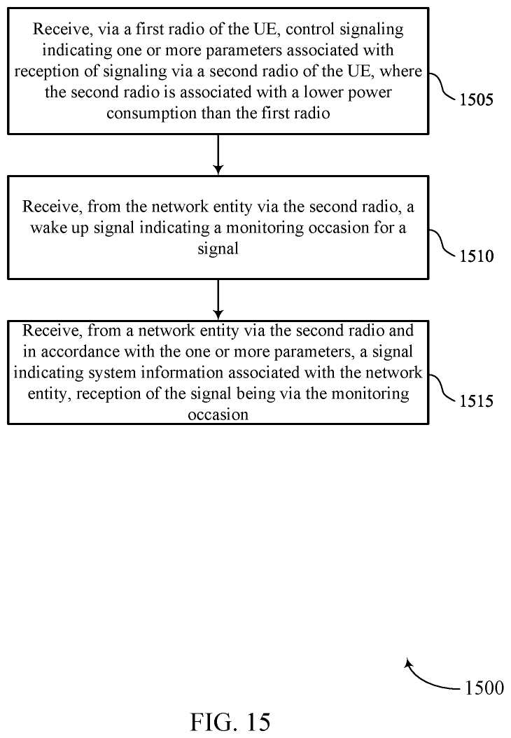

FIG. 15 illustrates a flowchart showing a method 1500 that supports receiving system information via wake up radio signals in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, via a first radio of the UE, control signaling indicating one or more parameters associated with reception of signaling via a second radio of the UE, where the second radio is associated with a lower power consumption than the first radio. The operations of 1505 may be performed in accordance with examples as disclosed herein. In some examples, aspects of the operations of 1505 may be performed by a wake up radio configuration manager 825 as described with reference to FIG. 8.

At 1510, the method may include receiving, from the network entity via the second radio, a WUS indicating a monitoring occasion for a signal. The operations of 1510 may be performed in accordance with examples as disclosed herein. In some examples, aspects of the operations of 1510 may be performed by a WUS manager 850 as described with reference to FIG. 8.

At 1515, the method may include receiving, from a network entity via the second radio and in accordance with the one or more parameters, a signal indicating system information associated with the network entity, reception of the signal being via the monitoring occasion. The operations of 1515 may be performed in accordance with examples as disclosed herein. In some examples, aspects of the operations of 1515 may be performed by a system information manager 830 as described with reference to FIG. 8.

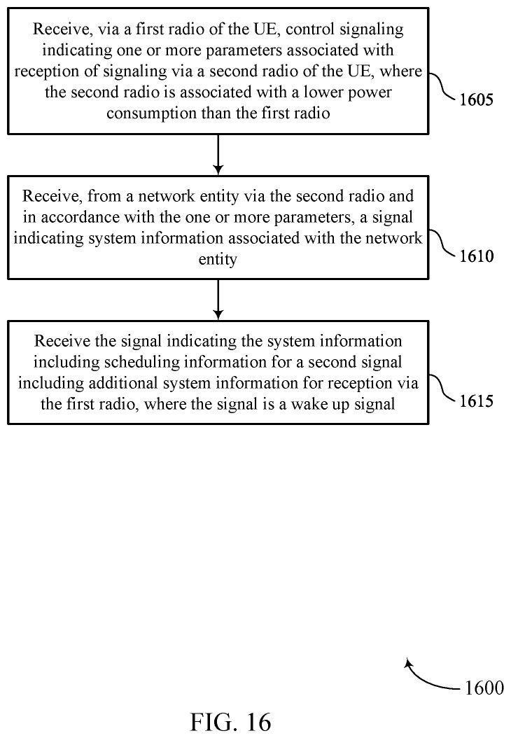

FIG. 16 illustrates a flowchart showing a method 1600 that supports receiving system information via wake up radio signals in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, via a first radio of the UE, control signaling indicating one or more parameters associated with reception of signaling via a second radio of the UE, where the second radio is associated with a lower power consumption than the first radio. The operations of 1605 may be performed in accordance with examples as disclosed herein. In some examples, aspects of the operations of 1605 may be performed by a wake up radio configuration manager 825 as described with reference to FIG. 8.

At 1610, the method may include receiving, from a network entity via the second radio and in accordance with the one or more parameters, a signal indicating system information associated with the network entity. The operations of 1610 may be performed in accordance with examples as disclosed herein. In some examples, aspects of the operations of 1610 may be performed by a system information manager 830 as described with reference to FIG. 8.

At 1615, the method may include receiving the signal indicating the system information including scheduling information for a second signal including additional system information for reception via the first radio, where the signal is a WUS. The operations of 1615 may be performed in accordance with examples as disclosed herein. In some examples, aspects of the operations of 1615 may be performed by a WUS manager 850 as described with reference to FIG. 8.

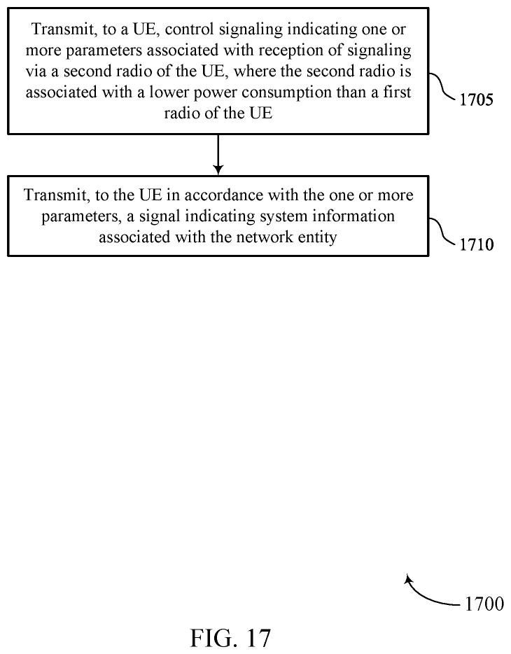

FIG. 17 illustrates a flowchart showing a method 1700 that supports receiving system information via wake up radio signals in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, control signaling indicating one or more parameters associated with reception of signaling via a second radio of the UE, where the second radio is associated with a lower power consumption than a first radio of the UE. The operations of 1705 may be performed in accordance with examples as disclosed herein. In some examples, aspects of the operations of 1705 may be performed by a wake up radio configuration manager 1225 as described with reference to FIG. 12.

At 1710, the method may include transmitting, to the UE in accordance with the one or more parameters, a signal indicating system information associated with the network entity. The operations of 1710 may be performed in accordance with examples as disclosed herein. In some examples, aspects of the operations of 1710 may be performed by a system information manager 1230 as described with reference to FIG. 12.

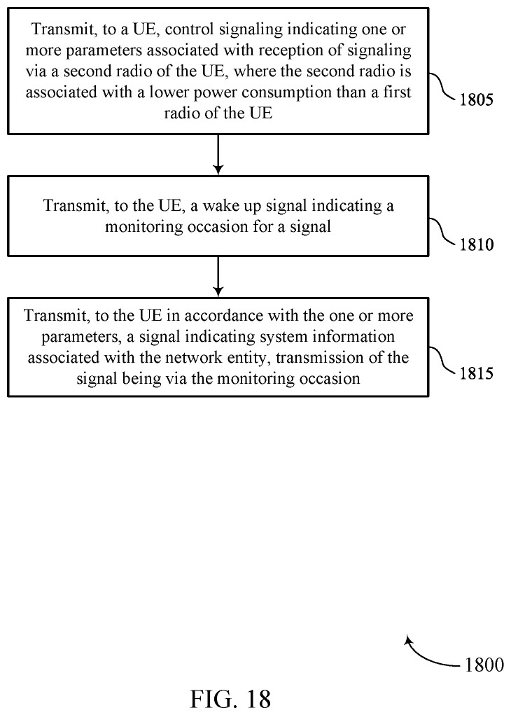

FIG. 18 illustrates a flowchart showing a method 1800 that supports receiving system information via wake up radio signals in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, control signaling indicating one or more parameters associated with reception of signaling via a second radio of the UE, where the second radio is associated with a lower power consumption than a first radio of the UE. The operations of 1805 may be performed in accordance with examples as disclosed herein. In some examples, aspects of the operations of 1805 may be performed by a wake up radio configuration manager 1225 as described with reference to FIG. 12.

At 1810, the method may include transmitting, to the UE, a WUS indicating a monitoring occasion for a signal. The operations of 1810 may be performed in accordance with examples as disclosed herein. In some examples, aspects of the operations of 1810 may be performed by a WUS manager 1245 as described with reference to FIG. 12.

At 1815, the method may include transmitting, to the UE in accordance with the one or more parameters, a signal indicating system information associated with the network entity, transmission of the signal being via the monitoring occasion. The operations of 1815 may be performed in accordance with examples as disclosed herein. In some examples, aspects of the operations of 1815 may be performed by a system information manager 1230 as described with reference to FIG. 12.

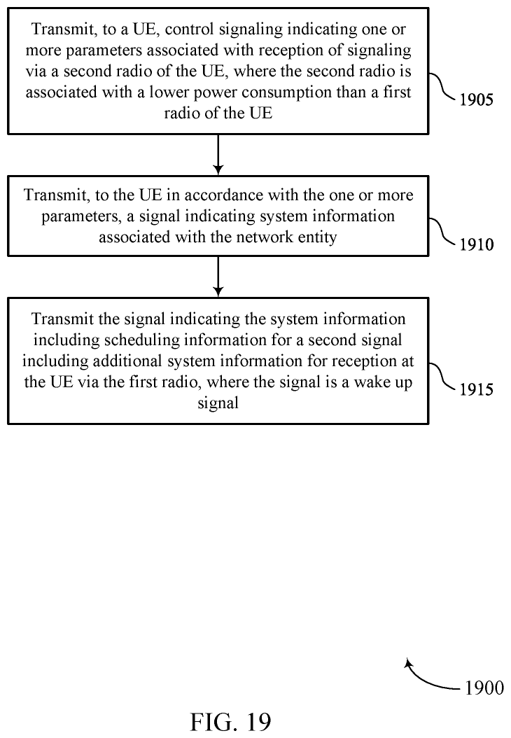

FIG. 19 illustrates a flowchart showing a method 1900 that supports receiving system information via wake up radio signals in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a UE, control signaling indicating one or more parameters associated with reception of signaling via a second radio of the UE, where the second radio is associated with a lower power consumption than a first radio of the UE. The operations of 1905 may be performed in accordance with examples as disclosed herein. In some examples, aspects of the operations of 1905 may be performed by a wake up radio configuration manager 1225 as described with reference to FIG. 12.

At 1910, the method may include transmitting, to the UE in accordance with the one or more parameters, a signal indicating system information associated with the network entity. The operations of 1910 may be performed in accordance with examples as disclosed herein. In some examples, aspects of the operations of 1910 may be performed by a system information manager 1230 as described with reference to FIG. 12.

At 1915, the method may include transmitting the signal indicating the system information including scheduling information for a second signal including additional system information for reception at the UE via the first radio, where the signal is a WUS. The operations of 1915 may be performed in accordance with examples as disclosed herein. In some examples, aspects of the operations of 1915 may be performed by a WUS manager 1245 as described with reference to FIG. 12.

The following provides an overview of aspects of the present disclosure:

Aspect 1: A method for wireless communications at a UE, comprising: receiving, via a first radio of the UE, control signaling indicating one or more parameters associated with reception of signaling via a second radio of the UE, wherein the second radio is associated with a lower power consumption than the first radio; and receiving, from a network entity via the second radio and in accordance with the one or more parameters, a signal indicating system information associated with the network entity.

Aspect 2: The method of aspect 1, wherein receiving the signal indicating the system information comprises: receiving the signal indicating the system information comprising a subset of information associated with a SIB, a subset of information associated with a MIB, an indication of a TDD pattern for communication via the first radio, a slot format indicator for communication with the network entity via the first radio, or scheduling information for an RRM measurement for the first radio.

Aspect 3: The method of any of aspects 1 through 2, wherein receiving the control signaling indicating the one or more parameters comprises: receiving the control signaling indicating the one or more parameters comprise a set of signal formats associated with a set of system information types, the signal having a signal format of the set of signal formats.

Aspect 4: The method of any of aspects 1 through 3, wherein receiving the signal comprises: receiving the signal via a reference signal resource or a synchronization signal resource.

Aspect 5: The method of any of aspects 1 through 4, wherein receiving the control signaling indicating the one or more parameters comprises: receiving the control signaling indicating the one or more parameters comprise a first format for SSBs associated with the second radio, a second format for SIBs associated with the second radio, a third format for CSI-RSs associated with the second radio, or a combination thereof, and wherein the signal comprises one of an SSB in the first format, a SIB in the second format, or a CSI-RS in the third format.

Aspect 6: The method of any of aspects 1 through 5, wherein receiving the signal comprises: receiving the signal while the first radio is in a sleep mode.

Aspect 7: The method of any of aspects 1 through 5, wherein receiving the signal comprises: receiving the signal while in communication with the network entity via the first radio.

Aspect 8: The method of any of aspects 1 through 7, further comprising: receiving, from the network entity via the second radio, a WUS indicating a monitoring occasion for the signal, reception of the signal being via the monitoring occasion.

Aspect 9: The method of aspect 8, wherein receiving the WUS comprises: receiving the WUS comprising a flag indicating the monitoring occasion is used for indicating the system information.

Aspect 10: The method of any of aspects 8 through 9, wherein a format of the WUS indicates that the monitoring occasion is used for indicating the system information.

Aspect 11: The method of any of aspects 1 through 10, wherein receiving the signal comprises: receiving the signal indicating the system information comprising scheduling information for a second signal comprising additional system information for reception via the first radio, wherein the signal is a WUS.

Aspect 12: The method of any of aspects 1 through 11, wherein receiving the signal indicating the system information comprises: receiving the signal indicating the system information comprising timing adjustment information for communication between the UE and the network entity via the first radio.

Aspect 13: The method of aspect 12, wherein the timing adjustment information comprises a first timing parameter and one or more second timing parameters indicated as differential values with respect to the first timing parameter.

Aspect 14: The method of any of aspects 12 through 13, wherein receiving the control signaling indicating the one or more parameters comprises: receiving an indication of a duration in DRX cycles for which the timing adjustment information is applicable.

Aspect 15: A method for wireless communications at a network entity, comprising: transmitting, to a UE, control signaling indicating one or more parameters associated with reception of signaling via a second radio of the UE, wherein the second radio is associated with a lower power consumption than a first radio of the UE; and transmitting, to the UE in accordance with the one or more parameters, a signal indicating system information associated with the network entity.

Aspect 16: The method of aspect 15, wherein transmitting the signal indicating the system information comprises: transmitting the signal indicating the system information comprising a subset of information associated with a SIB, a subset of information associated with a MIB, an indication of a TDD pattern for communication via the first radio, a slot format indicator for communication with the network entity via the first radio, or scheduling information for an RRM measurement for the first radio.

Aspect 17: The method of any of aspects 15 through 16, wherein transmitting the control signaling indicating the one or more parameters comprises: transmitting the control signaling indicating the one or more parameters comprise a set of signal formats associated with a set of system information types, the signal having a signal format of the set of signal formats.

Aspect 18: The method of any of aspects 15 through 17, wherein transmitting the signal comprises: transmitting the signal via a reference signal resource or a synchronization signal resource.

Aspect 19: The method of any of aspects 15 through 18, wherein transmitting the control signaling indicating the one or more parameters comprises: transmitting the control signaling indicating the one or more parameters comprise a first format for SSBs associated with the second radio, a second format for SIBs associated with the second radio, a third format for CSI-RSs associated with the second radio, or a combination thereof, and wherein the signal comprises one of an SSB in the first format, a SIB in the second format, or a CSI-RS in the third format.

Aspect 20: The method of any of aspects 15 through 19, further comprising: transmitting, to the UE, a WUS indicating a monitoring occasion for the signal, transmission of the signal being via the monitoring occasion.

Aspect 21: The method of aspect 20, wherein transmitting the WUS comprises: transmitting the WUS comprising a flag indicating the monitoring occasion is used for indicating the system information.

Aspect 22: The method of any of aspects 20 through 21, wherein a format of the WUS indicates that the monitoring occasion is used for indicating the system information.

Aspect 23: The method of any of aspects 15 through 22, wherein transmitting the signal comprises: transmitting the signal indicating the system information comprising scheduling information for a second signal comprising additional system information for reception at the UE via the first radio, wherein the signal is a WUS.

Aspect 24: The method of any of aspects 15 through 23, wherein transmitting the signal indicating the system information comprises: transmitting the signal indicating the system information comprising timing adjustment information for communication between the UE and the network entity via the first radio.

Aspect 25: The method of aspect 24, wherein the timing adjustment information comprises a first timing parameter and one or more second timing parameters indicated as differential values with respect to the first timing parameter.

Aspect 26: The method of any of aspects 24 through 25, wherein transmitting the control signaling indicating the one or more parameters comprises: transmitting an indication of a duration in DRX cycles for which the timing adjustment information is applicable.

Aspect 27: An apparatus for wireless communications at a UE, comprising at least one processor; and memory coupled with the at least one processor. the memory storing instructions for the at least one processor to cause the UE to perform a method of any of aspects 1 through 14.

Aspect 28: An apparatus for wireless communications at a UE, comprising at least one means for performing a method of any of aspects 1 through 14.

Aspect 29: A non-transitory computer-readable medium storing code for wireless communications at a UE, the code comprising instructions executable by at least one processor to perform a method of any of aspects 1 through 14.

Aspect 30: An apparatus for wireless communications at a network entity, comprising at least one processor; and memory coupled with the at least one processor. the memory storing instructions for the at least one processor to cause the network entity to perform a method of any of aspects 15 through 26.

Aspect 31: An apparatus for wireless communications at a network entity, comprising at least one means for performing a method of any of aspects 15 through 26.

Aspect 32: A non-transitory computer-readable medium storing code for wireless communications at a network entity, the code comprising instructions executable by at least one processor to perform a method of any of aspects 15 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
memory coupled with the at least one processor, the memory storing instructions for the at least one processor to cause the UE to:
receive, via a first radio of the UE, control signaling indicating one or more parameters associated with reception of signaling via a second radio of the UE, wherein the second radio is associated with a lower power consumption than the first radio; and
receive, from a network entity via the second radio and in accordance with the one or more parameters, a signal indicating system information associated with the network entity.

2. The apparatus of claim 1, wherein the instructions to receive the signal indicating the system information comprise instructions for the at least one processor to cause the UE to:
receive the signal indicating the system information comprising a subset of information associated with a system information block, a subset of information associated with a master information block, an indication of a time division duplexing pattern for communication via the first radio, a slot format indicator for communication with the network entity via the first radio, or scheduling information for a radio resource management measurement for the first radio.

3. The apparatus of claim 1, wherein the instructions to receive the control signaling indicating the one or more parameters comprise instructions for the at least one processor to cause the UE to:
receive the control signaling indicating the one or more parameters comprise a set of signal formats associated with a set of system information types, the signal having a signal format of the set of signal formats.

4. The apparatus of claim 1, wherein the instructions to receive the signal comprise instructions for the at least one processor to cause the UE to:
receive the signal via a reference signal resource or a synchronization signal resource.

5. The apparatus of claim 1, wherein the instructions to receive the control signaling indicating the one or more parameters comprise instructions for the at least one processor to cause the UE to:
receive the control signaling indicating the one or more parameters comprise a first format for synchronization signal blocks associated with the second radio, a second format for system information blocks associated with the second radio, a third format for channel state information reference signals associated with the second radio, or a combination thereof, and wherein the signal comprises one of a synchronization signal block in the first format, a system information block in the second format, or a channel state information reference signal in the third format.

6. The apparatus of claim 1, wherein the instructions to receive the signal comprise instructions for the at least one processor to cause the UE to:
receive the signal while the first radio is in a sleep mode.

7. The apparatus of claim 1, wherein the instructions to receive the signal comprise instructions for the at least one processor to cause the UE to:
receive the signal while in communication with the network entity via the first radio.

8. The apparatus of claim 1, wherein the instructions further comprise instructions for the at least one processor to cause the UE to:
receive, from the network entity via the second radio, a wake up signal indicating a monitoring occasion for the signal, reception of the signal being via the monitoring occasion.

9. The apparatus of claim 8, wherein the instructions to receive the wake up signal comprise instructions for the at least one processor to cause the UE to:
receive the wake up signal comprising a flag indicating the monitoring occasion is used for indicating the system information.

10. The apparatus of claim 8, wherein a format of the wake up signal indicates that the monitoring occasion is used for indicating the system information.

11. The apparatus of claim 1, wherein the instructions to receive the signal comprise instructions for the at least one processor to cause the UE to:
receive the signal indicating the system information comprising scheduling information for a second signal comprising additional system information for reception via the first radio, wherein the signal is a wake up signal.

12. The apparatus of claim 1, wherein the instructions to receive the signal indicating the system information comprise instructions for the at least one processor to cause the UE to:
receive the signal indicating the system information comprising timing adjustment information for communication between the UE and the network entity via the first radio.

13. The apparatus of claim 12, wherein the timing adjustment information comprises a first timing parameter and one or more second timing parameters indicated as differential values with respect to the first timing parameter.

14. The apparatus of claim 12, wherein the instructions to receive the control signaling indicating the one or more parameters comprise instructions for the at least one processor to cause the UE to:
receive an indication of a duration in discontinuous reception cycles for which the timing adjustment information is applicable.

15. An apparatus for wireless communications at a network entity, comprising:
at least one processor; and
memory coupled with the at least one processor, the memory storing instructions for the at least one processor to cause the network entity to:
transmit, to a user equipment (UE), control signaling indicating one or more parameters associated with reception of signaling via a second radio of the UE, wherein the second radio is associated with a lower power consumption than a first radio of the UE; and
transmit, to the UE in accordance with the one or more parameters, a signal indicating system information associated with the network entity.

16. The apparatus of claim 15, wherein the instructions to transmit the signal indicating the system information comprise instructions for the at least one processor to cause the network entity to:
transmit the signal indicating the system information comprising a subset of information associated with a system information block, a subset of information associated with a master information block, an indication of a time division duplexing pattern for communication via the first radio, a slot format indicator for communication with the network entity via the first radio, or scheduling information for a radio resource management measurement for the first radio.

17. The apparatus of claim 15, wherein the instructions to transmit the control signaling indicating the one or more parameters comprise instructions for the at least one processor to cause the network entity to:
transmit the control signaling indicating the one or more parameters comprise a set of signal formats associated with a set of system information types, the signal having a signal format of the set of signal formats.

18. The apparatus of claim 15, wherein the instructions to transmit the signal comprise instructions for the at least one processor to cause the network entity to:
transmit the signal via a reference signal resource or a synchronization signal resource.

19. The apparatus of claim 15, wherein the instructions to transmit the control signaling indicating the one or more parameters comprise instructions for the at least one processor to cause the network entity to:
transmit the control signaling indicating the one or more parameters comprise a first format for synchronization signal blocks associated with the second radio, a second format for system information blocks associated with the second radio, a third format for channel state information reference signals associated with the second radio, or a combination thereof, and wherein the signal comprises one of a synchronization signal block in the first format, a system information block in the second format, or a channel state information reference signal in the third format.

20. The apparatus of claim 15, wherein the instructions further comprise instructions for the at least one processor to cause the network entity to:
transmit, to the UE, a wake up signal indicating a monitoring occasion for the signal, transmission of the signal being via the monitoring occasion.

21. The apparatus of claim 20, wherein the instructions to transmit the wake up signal comprise instructions for the at least one processor to cause the network entity to:
transmit the wake up signal comprising a flag indicating the monitoring occasion is used for indicating the system information.

22. The apparatus of claim 20, wherein a format of the wake up signal indicates that the monitoring occasion is used for indicating the system information.

23. The apparatus of claim 15, wherein the instructions to transmit the signal comprise instructions for the at least one processor to cause the network entity to:
transmit the signal indicating the system information comprising scheduling information for a second signal comprising additional system information for reception at the UE via the first radio, wherein the signal is a wake up signal.

24. The apparatus of claim 15, wherein the instructions to transmit the signal indicating the system information comprise instructions for the at least one processor to cause the network entity to:
transmit the signal indicating the system information comprising timing adjustment information for communication between the UE and the network entity via the first radio.

25. The apparatus of claim 24, wherein the timing adjustment information comprises a first timing parameter and one or more second timing parameters indicated as differential values with respect to the first timing parameter.

26. The apparatus of claim 24, wherein the instructions to transmit the control signaling indicating the one or more parameters comprise instructions for the at least one processor to cause the network entity to:
transmit an indication of a duration in discontinuous reception cycles for which the timing adjustment information is applicable.

27. A method for wireless communications at a user equipment (UE), comprising:
receiving, via a first radio of the UE, control signaling indicating one or more parameters associated with reception of signaling via a second radio of the UE, wherein the second radio is associated with a lower power consumption than the first radio; and
receiving, from a network entity via the second radio and in accordance with the one or more parameters, a signal indicating system information associated with the network entity.

28. The method of claim 27, wherein receiving the signal indicating the system information comprises:
receiving the signal indicating the system information comprising a subset of information associated with a system information block, a subset of information associated with a master information block, an indication of a time division duplexing pattern for communication via the first radio, a slot format indicator for communication with the network entity via the first radio, or scheduling information for a radio resource management measurement for the first radio.

29. The method of claim 27, wherein receiving the control signaling indicating the one or more parameters comprises:
receiving the control signaling indicating the one or more parameters comprise a set of signal formats associated with a set of system information types, the signal having a signal format of the set of signal formats.

30. A method for wireless communications at a network entity, comprising:
transmitting, to a user equipment (UE), control signaling indicating one or more parameters associated with reception of signaling via a second radio of the UE, wherein the second radio is associated with a lower power consumption than a first radio of the UE; and
transmitting, to the UE in accordance with the one or more parameters, a signal indicating system information associated with the network entity.
